(19) United States
(12) Patent Application Publication
(10) Pub. No.: US 2005/0145822 A1
(43) Pub. Date: Jul. 7, 2005

(54) Refrigerant compositions comprising UV fluorescent dye and solubilizing agent

(76) Inventors: Martin D. Drigotas, Bloomfield Hills, MI (US); Thomas J. Leck, Hockessin, DE (US); David J. Bateman, Claymont, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/983,525

(22) Filed: Nov. 8, 2004

Related U.S. Application Data
(60) Provisional application No. 60/519,791, filed on Nov. 13, 2003.

(51) Int. Cl. C09K 5/00

(52) U.S. Cl. 252/68

(57) ABSTRACT

The present invention relates to refrigerant compositions comprising refrigerant, UV fluorescent dye and solubilizing agent that enable introduction of leak detectant UV fluorescent dye as solution of dye in refrigerant. Further, the present invention relates to methods for introducing dye, methods for solubilizing dye, methods for detecting leaks and methods for producing refrigeration and heat using the compositions described herein.

### CROSS REFERENCE(S) TO RELATED APPLICATION(S)

This application claims the priority benefit of U.S. Provisional Application 60/519,791, filed Nov. 13, 2003.

### BACKGROUND OF THE INVENTION

1. Field of the Invention

The present invention relates to refrigerant compositions comprising refrigerant, ultraviolet (UV) fluorescent dye and solubilizing agent that enable introduction of leak detectant UV fluorescent dye as solution of dye in refrigerant. Additionally, said compositions may contain a lubricant. Further, the present invention relates to methods for introducing dye, methods for solubilizing dye, methods for detecting leaks and methods for producing refrigeration and heat using the compositions described herein.

2. Description of Related Art

Hydrofluorocarbon (HFC) refrigerants have been adopted by the refrigeration and air conditioning industry as replacements for the chlorofluorocarbon (CFC) and hydrochlorofluorocarbon (HCFC) refrigerants, which have been found to contribute to the destruction of the stratospheric ozone layer.

The ability to detect leaks in any refrigeration or air conditioning apparatus is highly desirable in order to avoid costly recharging of refrigerant to the apparatus and reduce emissions to the atmosphere. Due to the numerous possible locations of leaks within an air conditioning apparatus, a means of identifying the location of a leak is also needed.

Ultra-violet (UV) fluorescent dyes have been used as leak detectants in CFC, HCFC and HFC refrigeration and air conditioning apparatus. The use of a hand-held UV light, allows the visual detection of leaking refrigerant containing the dye at the leaking location within the apparatus. Solubility of these UV fluorescent dyes, however, has been found to be at a low level for HFC-134a, a widely used HFC refrigerant, particularly at low temperatures. Therefore, methods for introducing these dyes into the refrigeration or air conditioning apparatus have been awkward, costly and time consuming. U.S. Pat. No. RE 36,951 describes a method, which utilizes a dye powder, solid pellet or slurry of dye that may be inserted into a component of the refrigeration or air conditioning apparatus. As refrigerant and lubricant are circulated through the apparatus, the dye is dissolved or dispersed and carried throughout the apparatus. Numerous other methods for introducing dye into a refrigeration or air conditioning apparatus are described in the literature.

Ideally, the UV fluorescent dye could be dissolved in the refrigerant itself thereby not requiring any specialized method for introduction to the refrigeration or air conditioning apparatus. The present invention relates to compositions of refrigerant and UV fluorescent dye, which may be introduced into the system as a solution of dye in the refrigerant. The inventive compositions will allow the storage and transport of dye-containing refrigerant even at low temperatures while maintaining the dye in solution.

### BRIEF SUMMARY OF THE INVENTION

The present invention relates to a leak-detectable refrigerant composition, said composition comprising: at least one refrigerant; at least one ultraviolet fluorescent dye; at least one solubilizing agent; and optionally, at least one lubricant, said lubricant being suitable for use in compression refrigeration or air conditioning apparatus.

The present invention further relates to a method for introducing an ultraviolet fluorescent dye into a compression refrigeration or air conditioning apparatus, said method comprising dissolving the ultraviolet fluorescent dye in the refrigerant in the presence of the solubilizing agent, and introducing the combination into said compression refrigeration or air conditioning apparatus.

The present invention further relates to a method for solubilizing ultraviolet fluorescent dye in refrigerant, said method comprising contacting the ultraviolet fluorescent dye with said refrigerant, in the presence of a solubilizing agent.

### DETAILED DESCRIPTION OF THE INVENTION

The following description is meant to fully define all aspects of the present invention.

The refrigerant of the present invention is selected from the group consisting of hydrofluorocarbons, fluoroethers, hydrocarbons, DME, CO₂, NH₃, and mixtures thereof.

The hydrofluorocarbon refrigerants of the present invention contain at least one carbon atom, at least one hydrogen atom and at least one fluorine atom. Of particular utility are hydrofluorocarbons having 1-6 carbon atoms containing at least one fluorine atom and having a normal boiling point of from −90° C. to 80° C. Hydrofluorocarbon refrigerants are commercial products available from a number of sources such as E.I. du Pont de Nemours & Co., Fluoroproducts, Wilmington, Del., 19898, USA, or are available from custom chemical synthesis companies such as PCR Inc., P.O. Box 1466, Gainesville, Florida, 32602, USA, and additionally by synthetic processes disclosed in art such as The Journal of Fluorine Chemistry, or Chemistry of Organic Fluorine Compounds, edited by Milos Hudlicky, published by The MacMillan Company, New York, N.Y., 1962. Representative hydrofluorocarbon refrigerants include but are not limited to: CHF₃ (HFC-23), CH₂F₂ (HFC-32), CH3F (HFC-41), CHF₂CF₃ (HFC-125), CHF₂CHF₂ (HFC-134), CH₂FCF₃ (HFC-134a), CHF₂CH₂F (HFC143), CF₃CH₃ (HFC-143a), CHF₂CH₃ (HFC-152a), CH₂FCH₃ (HFC-161), CHF₂CF₂CF₃ (HFC-227ca), CF₃CFHCF₃ (HFC-227ea), CHF₂CF₂CHF₂ (HFC-236ca), CH₂FCF₂CF₃ (HFC-236cb), CHF₂CHFCF₃ (HFC-236ea), CF₃CH₂CF₃ (HFC-236fa), CH₂FCF₂CHF₂ (HFC-245ca), CH₃CF₂CF₃ (HFC-245cb), CHF₂CHFCHF₂ (HFC-245ea), CH₂FCHFCF₃ (HFC-245eb), CHF₂CH₂CF₃ (HFC-245fa), CH₂FCF₂CH₂F (HFC-254ca), CH₂CF₂CHF₂ (HFC-254cb), CH₂FCHFCHF₂ (HFC-254ea), CH₃CHFCF₃ (HFC-254eb), CHF₂CH₂CHF₂ (HFC-254fa), CH₂FCH₂CF₃ (HFC-254fb), CH₃CF₂CH₃ (HFC-272ca), CH₃CHFCH₂F (HFC-272ea), CH₂FCH₂CH₂F (HFC-272fa), CH₃CH₂CF₂H(HFC-272fb), CH₃CHFCH₃ (HFC-281ea), CH₃CH₂CH₂F (HFC-281fa), CHF₂CF₂CF₂CF₂H(HFC-338 pcc), CF₃CHFCHFCF₂CF₃ (HFC43-10mee).

Hydrofluorocarbon refrigerants of the present invention may further comprise the azeotropic and azeotrope-like compositions, including HFC-125/HFC-143a/HFC-134a (known by the ASHRAE designation, R-404A), HFC-32/HFC-125/HFC-134a (known by ASHRAE designations, R-407A, R-407B, and R-407C), HFC-32/HFC-125 (R-410A), and HFC-125/HFC-143a (known by the ASHRAE designation: R-507) and others.

The fluoroether refrigerants of the present invention may comprise compounds similar to hydrofluorocarbons, which also contain at least one ether group oxygen atom. The fluoroether refrigerants include but are not limited to C₄F₉OCH₃, and C₄F₉OC₂H₅ (both available from 3M™, St. Paul, Minn.).

The refrigerants of the present invention may further comprise carbon dioxide (CO₂), ammonia (NH₃), dimethyl ether (DME) or hydrocarbon refrigerants, which contain only carbon and hydrogen atoms. Such hydrocarbon refrigerants include but are not limited to propane, propylene, cyclopropane, n-butane, isobutane, cyclobutane, n-pentane, iso-pentane (2-methylbutane), neo-pentane (2,2-dimethylpropane), cyclopentane. The hydrocarbon refrigerants may also be mixtures of more than one hydrocarbon compound.

By “ultra-violet” dye is meant any fluorescent dye that absorbs light in the ultraviolet or “near” ultraviolet region of the electromagnetic spectrum. The fluorescence produced by the UV fluorescent dye under illumination by an UV light that emits radiation with wavelength anywhere from 10 nanometer to 750 nanometer may be detected visually. Therefore, if refrigerant containing such an UV fluorescent dye is leaking from a given point in a refrigeration or air conditioning apparatus, the fluorescence will be visible at the leak point when illuminated by the appropriate wavelength light. Such UV fluorescent dyes include but are not limited to naphthalimides, perylenes, coumarins, anthracenes, phenanthracenes, xanthenes, thioxanthenes, naphthoxanthenes, fluoresceins, and derivatives or mixtures thereof. Many of said UV fluorescent dyes are described in the art. The most preferred UV dyes for leak detection applications are perylenes and naphthalimides. Perylenes fluoresce a brilliant yellow color when illuminated with long wave ultraviolet lamps. Naphthalimides fluoresce a brilliant green when exposed to UV and blue light.

Lubricants of the present invention may comprise those conventionally used in compression refrigeration apparatus utilizing chlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21. Lubricants of the present invention may comprise those commonly known as “mineral oils” in the field of compression refrigeration lubrication. Mineral oils comprise paraffins (i.e. straight chain and branched carbon-chain, saturated hydrocarbons), naphthenes (i.e. cyclic paraffins) and aromatics (i.e. unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e. linear and branched alkyl alkylbenzenes), synthetic paraffins and napthenes, and poly-alpha-olefins). Representative conventional lubricants of the present invention are the commercially available BVM 100 N (paraffinic mineral oil sold by BVA Oils), Suniso® 3GS (napthenic mineral oil sold by Crompton Co.), Sontex® 372LT (napthenic mineral oil sold by Pennzoil), Calumet® RO-30 (napthenic mineral oil sold by Calument Lubricants), Zerol® 75 and Zerol® 150 (linear alkylbenzenes sold by Shrieve Chemicals) and HAB 22 (branched alkylbenzene sold by Nippon Oil).

Lubricants of the present invention may further comprise those, which have been designed for use with hydrofluorocarbon refrigerants and are miscible with refrigerants of the present invention under compression refrigeration and air-conditioning apparatus' operating conditions. Such lubricants and their properties are discussed in “Synthetic Lubricants and High-Performance Fluids”, R. L. Shubkin, editor, Marcel Dekker, 1993. Such lubricants include, but are not limited to, polyol esters (POEs), polyalkylene glycols (PAGs), and polyvinyl ethers (PVEs).

Lubricants of the present invention are selected by considering a given compressor's requirements and the environment to which the lubricant will be exposed. Lubricants of the present invention preferably have a kinematic viscosity of at least about 7 cs (centistokes) at 40° C.

Solubilizing agents of the present invention comprise any compound found to enhance solubility of the UV dye in the refrigerant. The solubilizing agents of the present invention include compounds selected from the group consisting of hydrocarbons, dimethylether, polyoxyalkylene glycol ethers, amides, ketones, nitrites, chlorocarbons, esters, lactones, aryl ethers, fluoroethers, 1,1,1-trifluoroalkanes, and mixtures thereof. It should be understood that when the refrigerant comprises a hydrocarbon, the solubilizing agent may only be a different hydrocarbon.

The hydrocarbon solubilizing agents of the present invention further comprise hydrocarbons including straight chained, branched chain or cyclic alkanes or alkenes containing 5 or fewer carbon atoms and only hydrogen with no other functional groups. Hydrocarbon solubilizing agents include but are not limited to propane, propylene, cyclopropane, n-butane, isobutane, n-pentane, isopentane (2-methylbutane), neopentane (2,2-dimethylpropane), cyclopentane and mixtures thereof. It should be noted that if the refrigerant is a hydrocarbon, then the solubilizing agent may not be the same hydrocarbon.

Solubilizing agents of the present invention further comprise dimethyl ether (DME).

The polyoxyalkylene glycol ether solubilizing agents of the present invention comprise polyoxyalkylene glycol ethers represented by the formula R¹[(OR²)ₓOR³]_{y}, wherein: x is an integer from 1-3; y is an integer from 1-4; R¹ is selected from hydrogen and aliphatic hydrocarbon radicals having 1 to 6 carbon atoms and y bonding sites; R² is selected from aliphatic hydrocarbylene radicals having from 2 to 4 carbon atoms; R³ is selected from hydrogen and aliphatic and alicyclic hydrocarbon radicals having from 1 to 6 carbon atoms; at least one of R¹ and R³ is said hydrocarbon radical; and wherein said polyoxyalkylene glycol ethers have a molecular weight of from about 100 to about 300 atomic mass units. In the present polyoxyalkylene glycol ether solubilizing agents represented by R¹[(OR²)ₓOR³]_{y}: x is preferably 1-2; y is preferably 1; R¹ and R³ are preferably independently selected from hydrogen and aliphatic hydrocarbon radicals having 1 to 4 carbon atoms; R² is preferably selected from aliphatic hydrocarbylene radicals having from 2 or 3 carbon atoms, most preferably 3 carbon atoms; the polyoxyalkylene glycol ether molecular weight is preferably from about 100 to about 250 atomic mass units, most preferably from about 125 to about 250 atomic mass units. The R¹ and R³ hydrocarbon radicals having 1 to 6 carbon atoms may be linear, branched or cyclic. Representative R¹ and R³ hydrocarbon radicals include methyl, ethyl, propyl, isopropyl, butyl, isobutyl, sec-butyl, tert-butyl, pentyl, isopentyl, neopentyl, tert-pentyl, cyclopentyl, and cyclohexyl. Where free hydroxyl radicals on the present polyoxyalkylene glycol ether solubilizing agents may be incompatible with certain compression refrigeration apparatus materials of construction (e.g. Mylar®), R¹ and R³ are preferably aliphatic hydrocarbon radicals having 1 to 4 carbon atoms, most preferably 1 carbon atom. The R² aliphatic hydrocarbylene radicals having from 2 to 4 carbon atoms form repeating oxyalkylene radicals —(OR²)ₓ— that include oxyethylene radicals, oxypropylene radicals, and oxybutylene radicals. The oxyalkylene radical comprising R² in one polyoxyalkylene glycol ether solubilizing agent molecule may be the same, or one molecule may contain different R² oxyalkylene groups. The present polyoxyalkylene glycol ether solubilizing agents preferably comprise at least one oxypropylene radical. Where R¹ is an aliphatic or alicyclic hydrocarbon radical having 1 to 6 carbon atoms and y bonding sites, the radical may be linear, branched or cyclic. Representative R¹ aliphatic hydrocarbon radicals having two bonding sites include, for example, an ethylene radical, a propylene radical, a butylene radical, a pentylene radical, a hexylene radical, a cyclopentylene radical and a cyclohexylene radical. Representative R¹ aliphatic hydrocarbon radicals having three or four bonding sites include residues derived from polyalcohols, such as trimethylolpropane, glycerin, pentaerythritol, 1,2,3-trihydroxycyclohexane and 1,3,5-trihydroxycyclohexane, by removing their hydroxyl radicals.

Representative polyoxyalkylene glycol ether solubilizing agents include but are not limited to: CH₃OCH₂CH(CH₃)O(H or CH₃) (propylene glycol methyl (or dimethyl) ether), CH₃O[CH₂CH(CH₃)O]₂(H or CH₃) (dipropylene glycol methyl (or dimethyl) ether), CH₃O[CH₂CH(CH₃)O]₃(H or CH₃) (tripropylene glycol methyl (or dimethyl) ether), C₂H₅OCH₂CH(CH₃)O(H or C₂H₅) (propylene glycol ethyl (or diethyl) ether), C₂H₅O[CH₂CH(CH₃)O]₂(H or C₂H₅) (dipropylene glycol ethyl (or diethyl) ether), C₂H₅O[CH₂CH(CH₃)O]₃(H or C₂H₅) (tripropylene glycol ethyl (or diethyl) ether), C₃H₇OCH₂CH(CH₃)O(H or C₃H₇) (propylene glycol n-propyl (or di-n-propyl) ether), C₃H₇O[CH₂CH(CH₃)O]₂(H or C₃H₇) (dipropylene glycol n-propyl (or di-n-propyl) ether), C₃H₇O[CH₂CH(CH₃)O]₃(H or C₃H₇) (tripropylene glycol n-propyl (or di-n-propyl) ether), C₄H₉OCH₂CH(CH₃)OH (propylene glycol n-butyl ether), C₄H₉O[CH₂CH(CH₃)O]₂(H or C₄H₉) (dipropylene glycol n-butyl (or di-n-butyl)ether), C₄H₉O[CH₂CH(CH₃)O]₃(H or C₄H₉) (tripropylene glycol n-butyl (or di-n-butyl) ether), (CH₃)₃COCH₂CH(CH₃)OH (propylene glycol t-butyl ether), (CH₃)₃CO[CH₂CH(CH₃)O]₂(H or (CH₃)₃) (dipropylene glycol t-butyl (or di-t-butyl)ether), (CH₃)₃CO[CH₂CH(CH₃)O]₃(H or (CH₃)₃) (tripropylene glycol t-butyl (or di-t-butyl) ether), C₅H₁₁OCH₂CH(CH₃)OH (propylene glycol n-pentyl ether), C₄H₉OCH₂CH(C₂H₅)OH (butylene glycol n-butyl ether), C₄H₉O[CH₂CH(C₂H₅)O]₂H (dibutylene glycol n-butyl ether), trimethylolpropane tri-n-butyl ether (C₂H₅C(CH₂O(CH₂)₃CH₃)₃) and trimethylolpropane di-n-butyl ether (C₂H₅C(CH₂OC(CH₂)₃CH₃)₂CH₂OH).

The amide solubilizing agents of the present invention comprise amides represented by the formulae R¹CONR²R³ and cyclo-[R⁴CON(R⁵)—], wherein R¹, R², R³ and R⁵ are independently selected from aliphatic and alicyclic hydrocarbon radicals having from 1 to 12 carbon atoms; R⁴ is selected from aliphatic hydrocarbylene radicals having from 3 to 12 carbon atoms; and wherein said amides have a molecular weight of from about 100 to about 300 atomic mass units. The molecular weight of said amides is preferably from about 160 to about 250 atomic mass units. R¹, R², R³ and R⁵ may optionally include substituted hydrocarbon radicals, that is, radicals containing non-hydrocarbon substituents selected from halogens (e.g., fluorine, chlorine) and alkoxides (e.g. methoxy). R¹, R², R³ and R⁵ may optionally include heteroatom-substituted hydrocarbon radicals, that is, radicals, which contain the atoms nitrogen (aza-), oxygen (oxa-) or sulfur (thia-) in a radical chain otherwise composed of carbon atoms. In general, no more than three non-hydrocarbon substituents and heteroatoms, and preferably no more than one, will be present for each 10 carbon atoms in R¹⁻³, and the presence of any such non-hydrocarbon substituents and heteroatoms must be considered in applying the aforementioned molecular weight limitations. Preferred amide solubilizing agents consist of carbon, hydrogen, nitrogen and oxygen. Representative R¹, R², R³ and R⁵aliphatic and alicyclic hydrocarbon radicals include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers. A preferred embodiment of amide solubilizing agents are those wherein R⁴ in the aforementioned formula cyclo-[R⁴CON(R⁵)—] may be represented by the hydrocarbylene radical (CR⁶R⁷)ₙ, in other words, the formula: cyclo-[(CR⁶R⁷)ₙCON(R⁵)—] wherein: the previously-stated values for molecular weight apply; n is an integer from 3 to 5; R⁵ is a saturated hydrocarbon radical containing 1 to 12 carbon atoms; R⁶ and R⁷ are independently selected (for each n) by the rules previously offered defining R¹⁻³. In the lactams represented by the formula: cyclo-[(CR⁶R⁷)ₙCON(R⁵)—], all R⁶ and R⁷ are preferably hydrogen, or contain a single saturated hydrocarbon radical among the n methylene units, and R⁵ is a saturated hydrocarbon radical containing 3 to 12 carbon atoms. For example, 1-(saturated hydrocarbon radical)-5-methylpyrrolidin-2-ones.

Representative amide solubilizing agents include but are not limited to: 1-octylpyrrolidin-2-one, 1-decylpyrrolidin-2-one, 1-octyl-5-methylpyrrolidin-2-one, 1-butylcaprolactam, 1-cyclohexylpyrrolidin-2-one, 1-butyl-5-methylpiperid-2-one, 1-pentyl-5-methylpiperid-2-one, 1-hexylcaprolactam, 1-hexyl-5-methylpyrrolidin-2-one, 5-methyl-1-pentylpiperid-2-one, 1,3-dimethylpiperid-2-one, 1-methylcaprolactam, 1-butyl-pyrrolidin-2-one, 1,5-dimethylpiperid-2-one, 1-decyl-5-methylpyrrolidin-2-one, 1-dodecylpyrrolid-2-one, N,N-dibutylformamide and N,N-diisopropylacetamide.

The ketone solubilizing agents of the present invention comprise ketones represented by the formula R¹COR², wherein R¹ and R² are independently selected from aliphatic, alicyclic and aryl hydrocarbon radicals having from 1 to 12 carbon atoms, and wherein said ketones have a molecular weight of from about 70 to about 300 atomic mass units. R¹ and R² in said ketones are preferably independently selected from aliphatic and alicyclic hydrocarbon radicals having 1 to 9 carbon atoms. The molecular weight of said ketones is preferably from about 100 to 200 atomic mass units. R¹ and R² may together form a hydrocarbylene radical oconnected and forming a five, six, or seven-membered ring cyclic ketone, for example, cyclopentanone, cyclohexanone, and cycloheptanone. R¹ and R² may optionally include substituted hydrocarbon radicals, that is, radicals containing non-hydrocarbon substituents selected from halogens (e.g., fluorine, chlorine) and alkoxides (e.g. methoxy). R¹ and R² may optionally include heteroatom-substituted hydrocarbon radicals, that is, radicals, which contain the atoms nitrogen (aza-), oxygen (keto-, oxa-) or sulfur (thia-) in a radical chain otherwise composed of carbon atoms. In general, no more than three non-hydrocarbon substituents and heteroatoms, and preferably no more than one, will be present for each 10 carbon atoms in R¹ and R², and the presence of any such non-hydrocarbon substituents and heteroatoms must be considered in applying the aforementioned molecular weight limitations. Representative R¹ and R² aliphatic, alicyclic and aryl hydrocarbon radicals in the general formula R¹COR² include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers, as well as phenyl, benzyl, cumenyl, mesityl, tolyl, xylyl and phenethyl.

Representative ketone solubilizing agents include but are not limited to: 2-butanone, 2-pentanone, acetophenone, butyrophenone, hexanophenone, cyclohexanone, cycloheptanone, 2-heptanone, 3-heptanone, 5-methyl-2-hexanone, 2-octanone, 3-octanone, diisobutyl ketone, 4-ethylcyclohexanone, 2-nonanone, 5-nonanone, 2-decanone, 4-decanone, 2-decalone, 2-tridecanone, dihexyl ketone and dicyclohexyl ketone.

The nitrile solubilizing agents of the present invention further comprise nitriles represented by the formula R¹CN, wherein R¹ is selected from aliphatic, alicyclic or aryl hydrocarbon radicals having from 5 to 12 carbon atoms, and wherein said nitriles have a molecular weight of from about 90 to about 200 atomic mass units. R¹ in said nitrile solubilizing agents is preferably selected from aliphatic and alicyclic hydrocarbon radicals having 8 to 10 carbon atoms. The molecular weight of said nitrile solubilizing agents is preferably from about 120 to about 140 atomic mass units. R¹ may optionally include substituted hydrocarbon radicals, that is, radicals containing non-hydrocarbon substituents selected from halogens (e.g., fluorine, chlorine) and alkoxides (e.g. methoxy). R¹ may optionally include heteroatom-substituted hydrocarbon radicals, that is, radicals, which contain the atoms nitrogen (aza-), oxygen (keto-, oxa-) or sulfur (thia-) in a radical chain otherwise composed of carbon atoms. In general, no more than three non-hydrocarbon substituents and heteroatoms, and preferably no more than one, will be present for each 10 carbon atoms in R¹, and the presence of any such non-hydrocarbon substituents and heteroatoms must be considered in applying the aforementioned molecular weight limitations. Representative R¹ aliphatic, alicyclic and aryl hydrocarbon radicals in the general formula R¹CN include pentyl, isopentyl, neopentyl, tert-pentyl, cyclopentyl, cyclohexyl, heptyl, octyl, nonyl, decyl, undecyl, dodecyl and their configurational isomers, as well as phenyl, benzyl, cumenyl, mesityl, tolyl, xylyl and phenethyl.

Representative nitrile solubilizing agents include but are not limited to: 1-cyanopentane, 2,2-dimethyl-4-cyanopentane, 1-cyanohexane, 1-cyanoheptane, 1-cyanooctane, 2-cyanooctane, 1-cyanononane, 1-cyanodecane, 2-cyanodecane, 1-cyanoundecane and 1-cyanododecane.

The chlorocarbon solubilizing agents of the present invention comprise chlorocarbons represented by the formula RClₓ, wherein; x is selected from the integers 1 or 2; R is selected from aliphatic and alicyclic hydrocarbon radicals having 1 to 12 carbon atoms; and wherein said chlorocarbons have a molecular weight of from about 100 to about 200 atomic mass units. The molecular weight of said chlorocarbon solubilizing agents is preferably from about 120 to 150 atomic mass units. Representative R aliphatic and alicyclic hydrocarbon radicals in the general formula RClₓ include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers.

Representative chlorocarbon solubilizing agents include but are not limited to: 3-(chloromethyl)pentane, 3-chloro-3-methylpentane, 1-chlorohexane, 1,6-dichlorohexane, 1-chloroheptane, 1-chlorooctane, 1-chlorononane, 1-chlorodecane, and 1,1,1-trichlorodecane.

The ester solubilizing agents of the present invention comprise esters represented by the general formula R¹CO₂R², wherein R¹ and R² are independently selected from linear and cyclic, saturated and unsaturated, alkyl and aryl radicals. Preferred esters consist essentially of the elements C, H and O, have a molecular weight of from about 80 to about 550 atomic mass units. Representative esters include but are not limited to: (CH₃)₂CHCH₂OOC(CH₂)₂₋₄OCOCH₂CH(CH₃)₂ (diisobutyl dibasic ester), ethyl hexanoate, ethyl heptanoate, n-butyl propionate, n-propyl propionate, ethyl benzoate, di-n-propyl phthalate, benzoic acid ethoxyethyl ester, dipropyl carbonate, “Exxate 700” (a commercial C₇ alkyl acetate), “Exxate 800” (a commercial C₈ alkyl acetate), dibutyl phthalate, and tert-butyl acetate.

The lactone solubilizing agents of the present invention comprise lactones represented by structures [B], [C], and [D]: 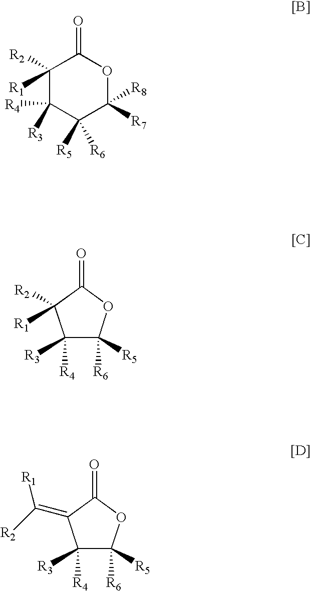
These lactones contain the functional group —CO₂— in a ring of six (B), or preferably five atoms (C), wherein for structures [B] and [C], R₁ through R₈ are independently selected from hydrogen or linear, branched, cyclic, bicyclic, saturated and unsaturated hydrocarbyl radicals. Each R₁ though R₈ may be connected forming a ring with another R₁ through R₈. The lactone may have an exocyclic alkylidene group as in structure [D], wherein R₁ through R₆ are independently selected from hydrogen or linear, branched, cyclic, bicyclic, saturated and unsaturated hydrocarbyl radicals. Each R₁ though R₆ may be connected forming a ring with another R₁ through R₆. The lactone solubilizing agents have a molecular weight range of from about 80 to about 300 atomic mass units, preferred from about 80 to about 200 atomic mass units.

Representative lactone solubilizing agents include but are not limited to the compounds listed in Table 1.

TABLE 1

| | | Molecular | Molecular |
|---|---|---|---|
| Additive | Molecular Structure | Formula | Weight (amu) |
| (E,Z)-3-ethylidene-5- methyl-dihydro-furan-2-one | 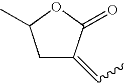 | C₇H₁₀O₂ | 126 |
| (E,Z)-3-propylidene-5- methyl-dihydro-furan-2-one | 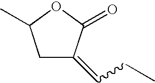 | C₈H₁₂O₂ | 140 |
| (E,Z)-3-butylidene-5- methyl-dihydro-furan-2-one | 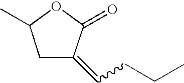 | C₉H₁₄O₂ | 154 |
| (E,Z)-3-pentylidene-5- methyl-dihydro-furan-2-one | 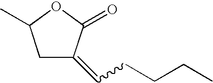 | C₁₀H₁₆O₂ | 168 |
| (E,Z)-3-Hexylidene-5- methyl-dihydro-furan-2-one | 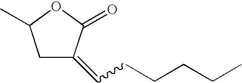 | C₁₁H₁₈O₂ | 182 |
| (E,Z)-3-Heptylidene-5- methyl-dihydro-furan-2-one | 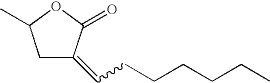 | C₁₂H₂₀O₂ | 196 |
| (E,Z)-3-octylidene-5- methyl-dihydro-furan-2-one | 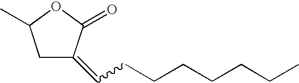 | C₁₃H₂₂O₂ | 210 |
| (E,Z)-3-nonylidene-5- methyl-dihydro-furan-2-one | 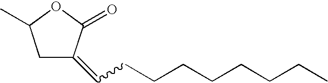 | C₁₄H₂₄O₂ | 224 |
| (E,Z)-3-decylidene-5- methyl-dihydro-furan-2-one | 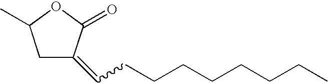 | C₁₅H₂₆O₂ | 238 |
| (E,Z)-3-(3,5,5- trimethylhexylidene)-5- methyl-dihydrofuran-2-one | 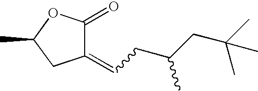 | C₁₄H₂₄O₂ | 224 |
| (E,Z)-3- cyclohexylmethylidene-5- methyl-dihydrofuran-2-one | 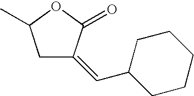 | C₁₂H₁₈O₂ | 194 |
| gamma-octalactone | 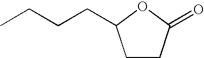 | C₈H₁₄O₂ | 142 |
| gamma-nonalactone | 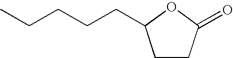 | C₉H₁₆O₂ | 156 |
| gamma-decalactone | 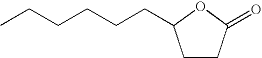 | C₁₀H₁₈O₂ | 170 |
| gamma-undecalactone | 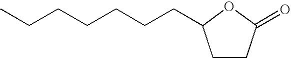 | C₁₁H₂₀O₂ | 184 |
| gamma-dodecalactone | 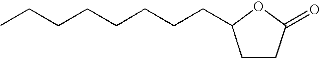 | C₁₂H₂₂O₂ | 198 |
| 3-hexyldihydro-furan-2-one | 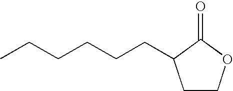 | C₁₀H₁₈O₂ | 170 |
| 3-heptyldihydro-furan-2-one | 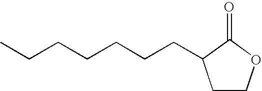 | C₁₁H₂₀O₂ | 184 |
| cis-3-ethyl-5-methyl- dihydro-furan-2-one | 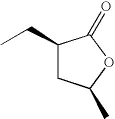 | C₇H₁₂O₂ | 128 |
| cis-(3-propyl-5-methyl)- dihydro-furan-2-one | 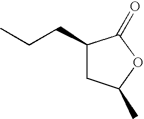 | C₈H₁₄O₂ | 142 |
| cis-(3-butyl-5-methyl)- dihydro-furan-2-one | 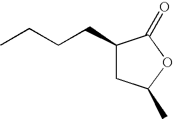 | C₉H₁₆O₂ | 156 |
| cis-(3-pentyl-5-methyl)- dihydro-furan-2-one | 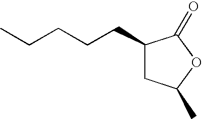 | C₁₀H₁₈O₂ | 170 |
| cis-3-hexyl-5-methyl- dihydro-furan-2-one | 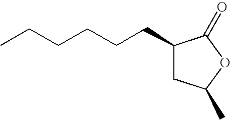 | C₁₁H₂₀O₂ | 184 |
| cis-3-heptyl-5-methyl- dihydro-furan-2-one | 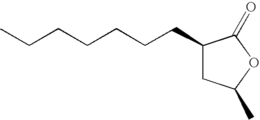 | C₁₂H₂₂O₂ | 198 |
| cis-3-octyl-5-methyl- dihydro-furan-2-one | 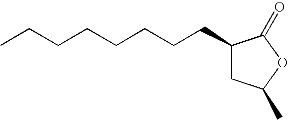 | C₁₃H₂₄O₂ | 212 |
| cis-3-(3,5,5-trimethylhexyl)- 5-methyl-dihydro-furan-2-one | 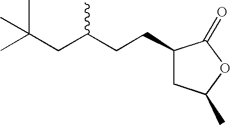 | C₁₄H₂₆O₂ | 226 |
| cis-3-cyclohexylmethyl-5- methyl-dihydro-furan-2-one | 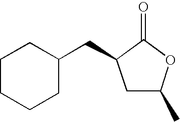 | C₁₂H₂₀O₂ | 196 |
| 5-methyl-5-hexyl-dihydro- furan-2-one | 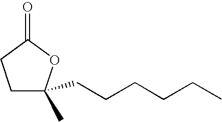 | C₁₁H₂₀O₂ | 184 |
| 5-methyl-5-octyl-dihydro- furan-2-one | 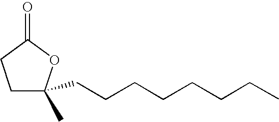 | C₁₃H₂₄O₂ | 212 |
| Hexahydro-isobenzofuran- 1-one | 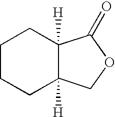 | C₈H₁₂O₂ | 140 |
| delta-decalactone | 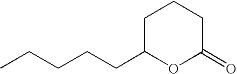 | C₁₀H₁₈O₂ | 170 |
| delta-undecalactone | 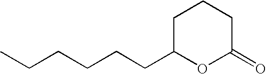 | C₁₁H₂₀O₂ | 184 |
| delta-dodecalactone | 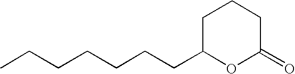 | C₁₂H₂₂O₂ | 198 |
| mixture of 4-hexyl- dihydrofuran-2-one and 3- hexyl-dihydro-furan-2-one | 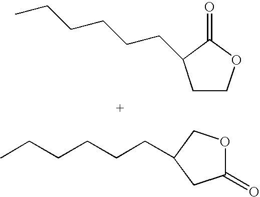 | C₁₀H₁₈O₂ | 170 |

Lactone solubilizing agents generally have a kinematic viscosity of less than about 7 centistokes at 40° C. For instance, gamma-undecalactone has kinematic viscosity of 5.4 centistokes and cis-(3-hexyl-5-methyl)dihydrofuran-2-one has viscosity of 4.5 centistokes both at 40° C. Lactone additives may be available commercially or prepared by methods as described in copending U.S. patent application Ser. No. 10/910,495, filed Aug. 7, 2004, incorporated herein by reference.

The aryl ether solubilizing agents of the present invention comprise aryl ethers represented by the formula R¹OR², wherein: R¹ is selected from aryl hydrocarbon radicals having from 6 to 12 carbon atoms; R² is selected from aliphatic hydrocarbon radicals having from 1 to 4 carbon atoms; and wherein said aryl ethers have a molecular weight of from about 100 to about 150 atomic mass units. Representative R¹ aryl radicals in the general formula R¹OR² include phenyl, biphenyl, cumenyl, mesityl, tolyl, xylyl, naphthyl and pyridyl. Representative R² aliphatic hydrocarbon radicals in the general formula R¹OR² include methyl, ethyl, propyl, isopropyl, butyl, isobutyl, sec-butyl and tert-butyl. Representative aromatic ether solubilizing agents include but are not limited to: methyl phenyl ether (anisole), 1,3-dimethyoxybenzene, ethyl phenyl ether and butyl phenyl ether.

The 1,1,1-trifluoroalkane solubilizing agents of the present invention further comprise 1,1,1-trifluoroalkanes represented by the general formula CF₃R¹, wherein R¹ is selected from aliphatic and alicyclic hydrocarbon radicals having from about 5 to about 15 carbon atoms, preferably primary, linear, saturated, alkyl radicals. Representative 1,1,1-trifluoroalkane solubilizing agents include but are not limited to: 1,1,1-trifluorohexane and 1,1,1-trifluorododecane.

The fluoroether solubilizing agents of the present invention comprise fluoroethers represented by the general formula R¹OCF₂CF₂H, wherein R¹ is selected from aliphatic and alicyclic hydrocarbon radicals having from about 5 to about 15 carbon atoms, preferably primary, linear, saturated, alkyl radicals. Representative fluoroether solubilizing agents include but are not limited to: C₈H₁₇OCF₂CF₂H and C₆H₁₃OCF₂CF₂H.

Solubilizing agents of the present invention may be present as a single compound, or may be present as a mixture of more than one solubilizing agent. Mixtures of solubilizing agents may contain more than one solubilizing agent from the same class of compounds, say two lactones, or more than one solubilizing agent from different classes, such as a lactone and a polyoxyalkylene glycol ether. Mixtures of solubilizing agents useful in the present invention may further contain 3 or more different solubilizing agents.

The compositions of the present invention may be prepared by any convenient method to combine the desired amount of the individual components. A preferred method is to weigh the desired component amounts and thereafter combine the components in an appropriate vessel. Agitation may be used, if desired.

In the present compositions comprising refrigerant, UV fluorescent dye and solubilizing agent, from about 1 to about 50 weight percent, preferably from about 2 to about 25 weight percent, and most preferably from about 5 to about 15 weight percent of the combined composition is solubilizing agent in the refrigerant. In the compositions of the present invention the UV fluorescent dye is present in a concentration from about 0.001 weight percent to about 1.0 weight percent in the refrigerant, preferably from 0.005 weight percent to about 0.5 weight percent, and most preferably from 0.01 weight percent to about 0.25 weight percent. Refrigerant and lubricant are present in the concentrations typically used in refrigeration and air conditioning apparatus for satisfactory performance.

Commonly used refrigeration system additives may optionally be added, as desired, to compositions of the present invention in order to enhance lubricity and system stability. These additives are generally known within the field of refrigeration compressor lubrication, and include anti wear agents, extreme pressure lubricants, corrosion and oxidation inhibitors, metal surface deactivators, free radical scavengers, foam control agents, and the like. In general, these additives are present only in small amounts relative to the overall lubricant composition. They are typically used at concentrations of from less than about 0.1 weight percent to as much as about 3 weight percent of each additive. These additives are selected on the basis of the individual system requirements. Some typical examples of such additives may include, but are not limited to, lubrication enhancing additives, such as alkyl or aryl esters of phosphoric acid and of thiophosphates. These include members of the triaryl phosphate family of EP lubricity additives, such as butylated triphenyl phosphates (BTPP), or other alkylated triaryl phosphate esters, e.g. Syn-0-Ad 8478 from Akzo Chemicals, tricrecyl phosphates and related compounds. Additionally, the metal dialkyl dithiophosphates (e.g. zinc dialkyl dithiophosphate or ZDDP, Lubrizol 1375) and other members of this family of chemicals may be used in compositions of the present invention. Other antiwear additives include natural product oils and asymmetrical polyhydroxyl lubrication additives such as Synergol TMS (International Lubricants). Similarly, stabilizers such as anti oxidants, free radical scavengers, and water scavengers may be employed. Compounds in this category can include, but are not limited to, butylated hydroxy toluene (BHT) and epoxides.

Solubilizing agents such as ketones may have an objectionable odor, which can be masked by addition of an odor masking agent or fragrance. Typical examples of odor masking agents or fragrances may include Evergreen, Fresh Lemon, Cherry, Cinnamon, Peppermint, Floral or Orange Peel or sold by Intercontinental Fragrance, as well as d-limonene and pinene. Such odor masking agents may be used at concentrations of from about 0.001% to as much as about 15% by weight based on the combined weight of odor masking agent and solubilizing agent.

Compositions of the present invention may optionally further comprise from about 0.5 to about 50 weight percent (based on total amount of solubilizing agent) of a linear or cyclic aliphatic or aromatic hydrocarbon containing from 6 to 15 carbon atoms. Representative hydrocarbons include hexane, octane, nonane, decane, Isopar® H (a high purity C₁ to C₁₂ iso-paraffinic), Aromatic 150 (a C₉ to C₁₁ aromatic), Aromatic 200 (a C₉ to C₁₅ aromatic) and Naptha 140. All of these hydrocarbons are sold by Exxon Chemical, USA.

Compositions of the present invention may optionally further comprise a polymeric additive. The polymeric additive may be a random copolymer of fluorinated and non-fluorinated acrylates, wherein the polymer comprises repeating units of at least one monomer represented by the formulae CH₂═C(R¹)CO₂R², CH₂═C(R³)C₆H₄R⁴, and CH₂═C(R⁵)C₆H₄XR⁶, wherein X is oxygen or sulfur; R¹, R³, and R⁵ are independently selected from the group consisting of H and C₁-C₄ alkyl radicals; and R², R⁴, and R⁶ are independently selected from the group consisting of carbon-chain-based radicals containing C, and F, and may further contain H, Cl, ether oxygen, or sulfur in the form of thioether, sulfoxide, or sulfone groups. Examples of such polymeric additives include those disclosed in U.S. Pat. No. 6,299,792, incorporated herein by reference, such as Zonyl® PHS sold by E.I. du Pont de Nemours & Co., Wilmington, Del., 19898, USA. Zonyl® PHS is a random copolymer made by polymerizing 40 weight percent CH₂═C(CH₃)CO₂CH₂CH₂(CF₂CF₂)ₘF (also referred to as Zonyl® fluoromethacrylate or ZFM) wherein m is from 1 to 12, primarily 2 to 8, and 60 weight percent lauryl methacrylate (CH₂═C(CH₃)CO₂(CH₂)₁₁CH₃, also referred to as LMA).

Compositions of the present invention may optionally further contain from about 0.01 to 30 weight percent (based on total amount of solubilizing agent) of an additive which reduces the surface energy of metallic copper, aluminum, steel, or other metals found in heat exchangers in a way that reduces the adhesion of lubricants to the metal. Examples of metal surface energy reducing additives include those disclosed in WIPO PCT publication WO 96/7721, such as Zonyl® FSA, Zonyl® FSP and Zonyl®) FSJ, all of which are products of E.I. du Pont de Nemours and Co. In practice, by reducing the adhesive forces between the metal and the lubricant (i.e. substituting for a compound more tightly bound to the metal), the lubricant circulates more freely through the heat exchangers and connecting tubing in an air conditioning or refrigeration system, instead of remaining as a layer on the surface of the metal. This allows for the increase of heat transfer to the metal and allows efficient return of lubricant to the compressor.

The present invention further relates to a method for introducing an ultraviolet fluorescent dye into a compression refrigeration or air conditioning apparatus, said method comprising dissolving the ultraviolet fluorescent dye in the refrigerant, and introducing the combination into said compression refrigeration or air conditioning apparatus.

Refrigeration or air-conditioning apparatus include but are not limited to centrifugal chillers, household refrigerator/freezers, residential air-conditioners, automotive air-conditioners, refrigerated transport vehickles, heat pumps, supermarket food coolers and display cases, and cold storage warehouses.

The present invention further relates to a method for solubilizing ultraviolet fluorescent dye in refrigerant, said method comprising contacting the ultraviolet fluorescent dye with said refrigerant in the presence of a solubilizing agent.

The present invention further relates to a method for detecting leaks, said method comprising using the composition comprising refrigerant, ultraviolet fluorescent dye and solubilizing agent. The method of detecting leaks for refrigeration and air conditioning apparatus with said ultraviolet fluorescent dye containing compositions involves using an ultraviolet lamp, often referred to as a “black light” or “blue light”. Such ultraviolet lamps are commercially available from numerous sources specifically designed for this purpose. Once the ultraviolet fluorescent dye containing composition has been introduced to the refrigeration or air conditioning apparatus and has been allowed to circulate throughout the system, a leak can be found by shining said ultraviolet lamp on the apparatus and observing the fluorescence of the dye in the vicinity of any leak point.

The present invention further relates to a method of using the leak detectable refrigerant composition of the present invention said method comprising:
(i) producing refrigeration by evaporating the leak detectable refrigerant composition in the vicinity of a body to be cooled and thereafter condensing said composition; or
(ii) producing heat by condensing the leak detectable refrigerant composition in the vicinity of the body to be heated and thereafter evaporating said composition.

### EXAMPLES

Solubility tests were run on several compositions in order to demonstrate the usefulness of the present invention. The test results are given below for each example. The UV dye used in all cases was Tracerline® TP3860, a dye concentrate (in lubricant), obtained from Spectronics Corporation (Wesbury, N.Y.).

### Example 1

Solubility tests were run for HFC-134a with TP3860 at different temperatures and concentrations (weight percent, wt %). The sample of refrigerant was mixed with dye and the temperature lowered until a precipitate (ppt) was formed. The results are given in Table 2.

TABLE 2

| wt % | | | | | | | | |
|---|---|---|---|---|---|---|---|---|
| dye in | 70° F. | 60° F. | 50° F. | 40° F. | 30° F. | 20° F. | 10° F. | 0° F. |
| 134a | 16 hrs | 2 hrs | 2 hrs | 2 hrs | 2 hrs | 16 hrs | 6 hrs | 16 hrs |
| 0.04% | Sol | Sol | Sol | Sol | Sol | Sol | Sol | Sol |
| 0.06% | Sol | Sol | Sol | Sol | Sol | Sol | Sol | Sol |
| 0.08% | Sol | Sol | Sol | Sol | Sol | Sol | Sol | ppt |
| 0.10% | Sol | Sol | Sol | Sol | Sol | ppt | — | — |
| 0.14% | Sol | Sol | Sol | ppt | — | — | — | — |
| 0.18% | Sol | Sol | Sol | ppt | — | — | — | — |
| 0.22% | Sol | Sol | ppt | — | — | — | — | — |
| 0.255% | Sol | Sol | ppt | — | — | — | — | — |

The results indicate limited solubility for UV dye in HFC-134a.

### Example 2

A solubility test comparing the solubility of TP3860 dye in both CFC-12 and HFC-152a (1,1-difluoroethane) was run. Additionally, solubility of the dye in HFC-152a with a solubilizing agent, dipropylene glycol dimethyl ether (DMM), was also determined. The two refrigerants were mixed with TP3860 dye concentrate at different concentrations (concentrations given in weight percent, wt %) and left in a freezer with the temperature controlled at −26° C. for about 4 days. The results are given in Table 3.

TABLE 3

| | | | | | | | 4 days |
|---|---|---|---|---|---|---|---|
| | Room | | | | | | at |
| Sample | Temp. | 4° C. | 0° C. | −10° C. | −20° C. | −26° C. | −26° C. |
| R-12 with | Sol | Sol | Sol | Sol | Sol | Yellow | Yellow |
| 0.1% | | | | | | line up | line up |
| TP3860 | | | | | | side of | side of |
| | | | | | | bottle | bottle |
| R-12 with | Sol | Sol | Sol | Sol | Sol | Yellow | Yellow |
| 0.2% | | | | | | line up | line up |
| TP3860 | | | | | | side of | side of |
| | | | | | | bottle | bottle |
| R-12 with | Sol | Sol | Sol | Sol | Sol | Yellow | Yellow |
| 0.3% | | | | | | line up | line up |
| TP3860 | | | | | | side of | side of |
| | | | | | | bottle | bottle |
| R-152a | Sol | Sol | Sol | Sol | Sol | Sol | Yellow |
| with 0.1% | | | | | | | ring |
| TP3860 | | | | | | | |
| R-152a | Sol | Sol | Sol | Sol | Sol | Sol | Yellow |
| with 0.2% | | | | | | | ring |
| TP3860 | | | | | | | |
| R-152a | Sol | Sol | Sol | Sol | Sol | Yellow | Yellow |
| with 0.3% | | | | | | ring | ring |
| TP3860 | | | | | | | |
| R-152a | Sol | Sol | Sol | Sol | Sol | Sol | Sol |
| with 0.1% | | | | | | | |
| TP3860 | | | | | | | |
| and 1% | | | | | | | |
| DMM | | | | | | | |
| R-152a | Sol | Sol | Sol | Sol | Sol | Sol | Sol |
| with 0.2% | | | | | | | |
| TP3860 | | | | | | | |
| and 1% | | | | | | | |
| DMM | | | | | | | |
| R-152a | Sol | Sol | Sol | Sol | Sol | Sol | Sol |
| with 0.3% | | | | | | | |
| TP3860 | | | | | | | |
| and 1% | | | | | | | |
| DMM | | | | | | | |

The data demonstrates the improved dye solubility for the HFC-152a composition including the solubilizing agent.

### Example 3

Solubility tests were run on mixtures of HFC-32 and TP3860 dye at −24° C. Additionally, HFC-32 was first mixed with a solubilizing agent, n-butane, and then the solubility was determined at −24° C. The results are given in Table 4.

TABLE 4

| | Observations of mixtures at −24° C. for about | |
|---|---|---|
| | one month | |
| | | HFC-32 + 5% |
| Concentration of dye | HFC-32 | n-butane |
| 0.1 wt % dye in | Dye covered the wall of | Clear solution |
| refrigerant | liquid phase | |
| 0.2 wt % dye in | Dye covered the wall of | Clear solution |
| refrigerant | liquid phase | |
| 0.3 wt % dye in | Dye covered the wall of | Dye covered the wall |
| refrigerant | liquid phase | of liquid phase |

The results show that while the UV dye is insoluble in HFC-32 alone at all three concentrations tested, the addition of a solubilizing agent, n-butane, provides solubility for the 0.1 wt % and 0.2 wt % concentrations.

1. A leak-detectable refrigerant composition, said composition comprising:
a) at least one refrigerant;
b) at least one ultraviolet fluorescent dye;
c) at least one solubilizing agent; and
d) optionally, at least one lubricant, said lubricant being suitable for use in compression refrigeration or air conditioning apparatus.

2. The composition of claim 1 wherein the refrigerant is selected from the group of hydrofluorocarbons, fluoroethers, hydrocarbons, DME, CO₂, NH₃, and mixtures thereof.

3. The composition of claim 1 or 2 wherein the ultraviolet fluorescent dye is at least one selected from the group consisting of naphthalimides, perylenes, coumarins, anthracenes, phenanthracenes, xanthenes, thioxanthenes, naphthoxanthenes, fluoresceins, and derivatives thereof.

4. The composition of claim 1 or 2 wherein the solubilizing agent is selected from the group consisting of hydrocarbons, dimethylether, polyoxyalkylene glycol ethers, amides, ketones, nitriles, chlorocarbons, esters, lactones, aryl ethers, fluoroethers, 1,1,1-trifluoroalkanes, and mixtures thereof; and wherein when the refrigerant comprises a hydrocarbon, the solubilizing agent may only be a different hydrocarbon.

5. The composition of claim 1 or 2 wherein said solubilizing agent is selected from the group consisting of:
a) polyoxyalkylene glycol ethers represented by the formula R¹[(OR²)ₓOR³]_{y}, wherein: x is an integer from 1 to 3; y is an integer from 1 to 4; R¹ is selected from hydrogen and aliphatic hydrocarbon radicals having 1 to 6 carbon atoms and y bonding sites; R² is selected from aliphatic hydrocarbylene radicals having from 2 to 4 carbon atoms; R³ is selected from hydrogen, and aliphatic and alicyclic hydrocarbon radicals having from 1 to 6 carbon atoms; at least one of R¹ and R³ is selected from said hydrocarbon radicals; and wherein said polyoxyalkylene glycol ethers have a molecular weight of from about 100 to about 300 atomic mass units;
b) amides represented by the formulae R¹CONR²R³ and cyclo-[R⁴CON(R⁵)—], wherein R¹, R², R³ and R⁵ are independently selected from aliphatic and alicyclic hydrocarbon radicals having from 1 to 12 carbon atoms, and at most one aromatic radical having from 6 to 12 carbon atoms; R⁴ is selected from aliphatic hydrocarbylene radicals having from 3 to 12 carbon atoms; and wherein said amides have a molecular weight of from about 100 to about 300 atomic mass units;
c) ketones represented by the formula R¹COR², wherein R¹ and R² are independently selected from aliphatic, alicyclic and aryl hydrocarbon radicals having from 1 to 12 carbon atoms, and wherein said ketones have a molecular weight of from about 70 to about 300 atomic mass units;
d) nitriles represented by the formula R¹CN, wherein R¹ is selected from aliphatic, alicyclic or aryl hydrocarbon radicals having from 5 to 12 carbon atoms, and wherein said nitriles have a molecular weight of from about 90 to about 200 atomic mass units;
e) chlorocarbons represented by the formula RClₓ, wherein; x is selected from the integers 1 or 2; R is selected from aliphatic and alicyclic hydrocarbon radicals having from 1 to 12 carbon atoms; and wherein said chlorocarbons have a molecular weight of from about 100 to about 200 atomic mass units;
f) aryl ethers represented by the formula R¹OR², wherein: R¹ is selected from aryl hydrocarbon radicals having from 6 to 12 carbon atoms; R² is selected from aliphatic hydrocarbon radicals having from 1 to 4 carbon atoms; and wherein said aryl ethers have a molecular weight of from about 100 to about 150 atomic mass units;
g) 1,1,1-trifluoroalkanes represented by the formula CF₃R¹, wherein R¹ is selected from aliphatic and alicyclic hydrocarbon radicals having from about 5 to about 15 carbon atoms;
h) fluoroethers represented by the formula R¹OCF₂CF₂H, wherein R¹ is selected from aliphatic and alicyclic hydrocarbon radicals having from about 5 to about 15 carbon atoms; and
i) lactones represented by structures [B], [C], and [D]: 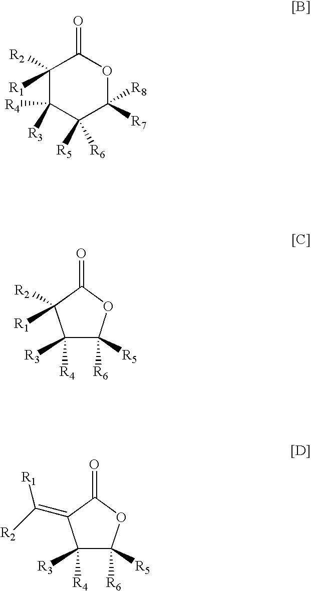
wherein, R₁ through R₈ are independently selected from hydrogen, linear, branched, cyclic, bicyclic, saturated and unsaturated hydrocarbyl radicals; and the molecular weight is from about 100 to about 300 atomic mass units; and
i) esters represented by the general formula R¹CO₂R², wherein R¹ and R² are independently selected from linear and cyclic, saturated and unsaturated, alkyl and aryl radicals; and wherein said esters have a molecular weight of from about 80 to about 550 atomic mass units.

6. The composition of claim 1 wherein said refrigerant is a hydrofluorocarbon and wherein said solubilizing agent is dimethyl ether.

7. The composition of claim 1 wherein at least one of said lubricant is selected from the group consisting of mineral oils, paraffins, naphthenes, synthetic paraffins, alkylbenzenes, poly-alpha-olefins, polyalkylene glycols, polyvinyl ethers, and polyol esters.

8. A method for introducing an ultraviolet fluorescent dye into a compression refrigeration or air conditioning apparatus, said method comprising dissolving the ultraviolet fluorescent dye in the refrigerant in the presence of the solubilizing agent, and introducing the combination into said compression refrigeration or air conditioning apparatus.

9. A method for solubilizing ultraviolet fluorescent dye in refrigerant, said method comprising contacting the ultraviolet fluorescent dye with said refrigerant, in the presence of a solubilizing agent.

10. A method for detecting leaks, said method comprising using the composition of claim 1 in a compression refrigeration or air conditioning apparatus, said method comprising providing said apparatus, and providing a suitable means for detecting said composition in the vicinity of said apparatus.

11. A method of using the leak detectable refrigerant composition of claim 1 said method comprising:
(i) producing refrigeration by evaporating the leak detectable refrigerant composition in the vicinity of a body to be cooled and thereafter condensing said composition; or
(ii) producing heat by condensing the leak detectable refrigerant composition in the vicinity of the body to be heated and thereafter evaporating said composition.
